(19) United States
(12) Patent Application Publication
(10) Pub. No.: US 2006/0019040 A1
(43) Pub. Date: Jan. 26, 2006

(54) Hydrogen diffusion barrier on steel by means of a pulsed-plasma ion-nitriding process

(75) Inventors: Paulo Emilio Valadao Miranda, Rio de Janeiro (BR); Jorge Nestor Feugeas, Rosario (AR); Blanca Prazim Trotta, Sao Paulo (BR)

Correspondence Address: Fildes & Outland, Suite 2, 20916 Mack Avenue, Grosse Pointe Woods, MI, 48236, US

(73) Assignee: COPPE/UFRJ-Coordenacao dos Programas de Pos Graduacao de Engenharia da Universidade Federal, Rio de Janeiro, RJ-cep21941-590 (BR)

(21) Appl. No.: 10/538,694

(22) PCT Filed: Nov. 19, 2003
(86) PCT No.: PCT/BR03/00169

§ 371 Date: Jun. 10, 2005

(30) Foreign Application Priority Data
Dec. 20, 2002 (BR) PI 0205419-1

(51) Int. Cl. H05H 1/24

(52) U.S. Cl. 427/569

(57) ABSTRACT

Patente of invention for “Hydrogen Diffusion Barrier on Steel by Means of a Pulsed-Plasmalon-Nitriding Process”. The present invention refers to a pulsed-plasma ion-nitriding process performed with the objective of creating hydrogen diffusion barrier on steel, herein exemplified by using the API 5L X-65 steel; high-strength low-alloy steel. The pulsed-plasma ion-nitriding consisted to drive ions and active species of atomic and molecular nitrogen to the material's surface by applying a difference of potential between two electrodes, periodically interrupted with a pre-determined frequency, such that the cathode (1) is the own material or piece to be treated, in a chamber (2) that was previously vacuum pumped (4) and then filled up (6) with the gas nitrogen or a gaseous mixture containing this gas.

### TECHNICAL FIELD

The present invention concerns a pulsed-plasma ion- nitriding process with the aim of creating hydrogen diffusion barriers on steels, being exemplified here for an API 5L X-65 high strength low alloy steel.

### PRECEDING PROCEDURES

Conventionally thermo-chemical processes concerning the diffusion of the non-metallic element nitrogen into the surfaces of engineering components are carried out by mass transfer using solid, liquid or gaseous environments with the aim of increasing surface hardness.

The gaseous nitriding is among the conventional processes through which nitrogen is introduced in the surface of the material by dissociating ammonia onto such surface, at temperatures varying between 495 and 565° C., and the liquid nitriding, using fused cyanate and cyanide salt baths in temperatures between 500 and 575° C. The advent of a nitriding process using plasma to drive nitrogen onto the material's surface, substituting the conventional processes, brought many combined advantages such as the increase on hardness, wear, fatigue and corrosion resistances, as well as better magnetic properties. The advantages including the process itself include: better control of the material's microstructure, and consequently of the desired material's properties; reduction on the energy consumption up to 50% and of the treatment time from 30 to 50%; reduction on the gas consumption; elimination of environmental pollution and of risks of explosion and contamination with toxics wastes, such as cyanide; the possibility to use lower temperatures in a wide range varying from room temperature to 400° C., preferentially in temperatures between 300 and 400° C., therefore decreasing structural distortions and phase changes.

The ion-nitriding may be obtained by using continuous or pulsed current with varied frequencies. Basically, the difference between the continuous and the pulsed mode is the interruption of the applied voltage, which brings benefits making the pulsed-plasma ion-nitriding process to present advantages as compared to the continuous- plasma process, such as the reduction on the amount of ions that reach the sample surface, by converting them into neutral atoms through the recombination with electrons during the interruption of the electric discharge, therefore increasing the efficiency of the process and reducing the cathodic sputtering of the material's surface.

### DETAILED DESCRIPTION OF THE INVENTION

The innovation herein proposed describes a pulsed- plasma ion-nitriding process that consists to guide ions and active species of atomic and molecular nitrogen to the surface of the material, by means of applying a potential difference between two electrodes, which is periodically interrupted with a pre-determined frequency, being the cathode the material itself (or component) to be treated, in a previously evacuated chamber into which the gas nitrogen or a gaseous mixture containing this gas is introduced. A potential difference is applied for a certain time, the discharge time t_{d}, and interrupted for another period of time, the post-discharge time t_{pd}, creating a glow discharge that assures both a total coverage of the cathode and sufficient heat to the material to be nitrided that an external heat source may not be necessary. The percentage of the pulse in which the voltage is applied is known as active time tₐ. During the time in which the potential difference is applied electrical discharges are produced, generating plasma (ionized gas). In these conditions working gas, nitrogen, ions are created, which are driven by the potential difference to the cathode, the piece to be treated.

Surface modifications are created in the material, generating two distinct layers: the white layer or composed layer, made out of iron nitrides, followed by the diffusion zone that contains nitrogen in solid solution into the ferrite and iron nitrides. Besides obtaining better surface properties, such as the increase on hardness, corrosion resistance and fatigue resistance, the present work proposes the pulsed-plasma ion-nitriding as a process to reduce the hydrogen permeability through the material. This was exemplified by using the API 5L X-65 steel, with the chemical composition depicted in Table 1, as a model to present the effects of pulsed-plasma ion-nitriding, specially those related to hydrogen. The samples were pulsed-plasma ion- nitrided on only one of their sides.

TABLE 1
Chemical composition of the API 5L X-65 steel (wheight %).

| | | | | | |
|---|---|---|---|---|---|
| C | 0.11 | Si | 0.29 | Nb | 0.032 |
| Mn | 1.05 | Al | 0.035 | V | 0.055 |
| S | 0.005 | Ni | 0.15 | Ti | 0.010 |
| p | 0.014 | Cu | 0.31 | Ca | 0.00747 |

Fe - balance

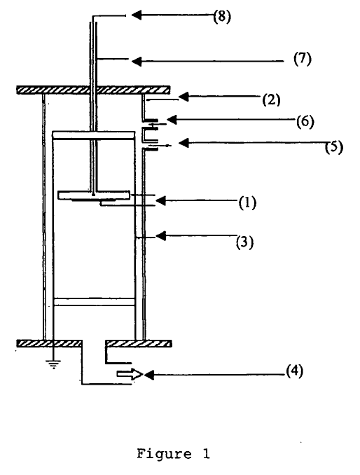

The first step of the pulsed-plasma ion-nitriding process consisted of positioning the sample (1) that is the cathode itself into the nitriding chamber (2), whose internal wall is the anode (3), evacuated by a vacuum pump (4) until the pressure gauge (5) indicated a pressure of, for example, 30 mTorr (3.99×10⁻⁶ MPa). A gas inlet (6) allowed the introduction of a gaseous mixture rich in nitrogen, in percentages that varied in the range, although the gaseous mixture preferentially used was in the range N₂+0%-20% H₂, and a working pressure of, for example, 4 Torr (5.33×10⁻⁴ MPa) was chosen. The potential difference (7) was applied in such a way that the temperature within the chamber was, for example, in the range 300 to 400° C., measured by a thermocouple (8). The nitriding times were evaluated by summing the periods of time in which the plasma was active, in order to maintain this total time at a fixed value. Upon finishing the nitriding, the samples were cooled down in the nitriding chamber in a nitrogen atmosphere. FIG. 1 presents a schematic arrangement of the pulsed-plasma ion-nitriding system used.

Examples of conditions used in the pulsed-plasma ion-nitriding of the API 5L X-65 steel:
Frequency equal to about 100 Hz; active time between 40 and 80%; nitriding time in the range of 4 to 8 hours; discharge time of around 4.0 to 8.0 ms; post-discharge time between 2 and 6 ms; potential difference in the range of 360 to 410 V; and current density between 3.0 and 5.0 mA.cm⁻²;
Frequency equal to about 500 Hz; active time between 50 and 80%; nitriding time in the range of 3 to 6 hours; discharge time of around 1.0 to 2.0 ms; post-discharge time between 0.2 and 1.0 ms; potential difference in the range of 350 to 400 V; and current density between 3.0 and 5.0 mA.cm⁻²;
   Experimental Techniques

The double-potentiostatic electrochemical method was the technique used for the determination of hydrogen permeability in metallic materials. However, a step was required before the permeation, the potentiodynamic polarization test, with the aim of defining the cathodic potential or current for hydrogen generation, to be used in the permeation test.

The potentiodynamic polarization test consisted on the application of a potential ramp, varying at a rate of, for example, 600 mV.h⁻, between the work electrode that was the sample to be analyzed and the platinum counter electrode, displacing it with respect to the open circuit potential (the approximately constant open circuit potential measured between the work electrode and the saturated calomel reference electrode) to the direction of positive potential values, anodic, or to the direction of negative potential values, cathodic, depending on the analysis to be made, while the resulting current was monitored. During the test a convenient electrolyte was used, for example, a 0.1 N NaOH solution that was bubbled with gas nitrogen. The electrochemical reactions that may take place during the application of the potential in the range −2V to +2V are, respectively, the reduction reaction, through which the sample is reduced by gaining electrons (cathodic polarization) and the oxidation reaction, through which the sample is oxidized by loosing electrons (anodic polarization).

The hydrogen permeation parameters were determined from electrochemical hydrogen permeation tests with cathodic charging making use of a programmable electrochemical interface that allowed the control of parameters and data acquisition by means of a microcomputer and a two compartment electrochemical cell, presenting one side to generate hydrogen and the other for its detection. With such an apparatus currents and potentials were measured and applied with resolutions of 1 nA and 0.1 mV, respectively. The temperature was thermostatically controlled and measured with silicon transistors, with a resolution of 0.01° C., guaranteeing temperature variations during the test smaller than +/−0.1° C.

For the nitrided samples, the tests were conducted following two different orientations: generating hydrogen on the sample's nitrided face and detecting it on the sample's non-nitrided (substrate) face and, conversely, generating hydrogen on the sample's non-nitrided (substrate) face and detecting it on the sample's nitrided face. Electrochemical hydrogen tests were also conducted using non-nitrided samples with the objective of obtaining the substrate's permeation parameters. All tests herein shown with the objective of exemplifying the role of hydrogen diffusion barrier played by the nitrided layer were conducted at the temperature of 50° C.

Results

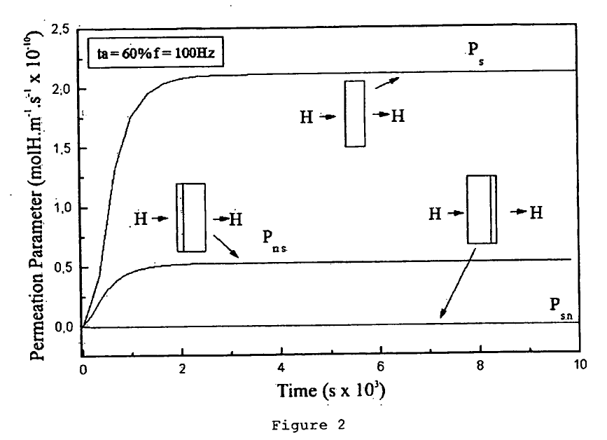

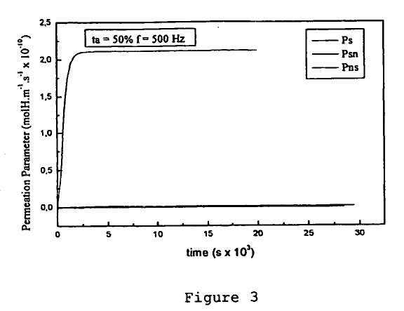

Curves of hydrogen permeation parameter versus time were plotted based on the results obtained from the hydrogen permeation tests. The hydrogen permeation parameter is equal to the product of the hydrogen flux by the sample thickness for each time during a test. The hydrogen permeation parameters for the pulsed-plasma ion-nitrided samples were obtained in two different ways: by generating hydrogen on the nitrided face and detecting it on the substrate face (curve marked Pₙₛ, on FIGS. 2 and 3) and, conversely, by generating hydrogen on the substrate face and detecting it on the nitrided face (curve marked Pₛₙ on FIGS. 2 and 3). FIGS. 2 and 3 exemplify two specific pulsed-plasma ion-nitriding conditions: using frequencies of 100 Hz and 500 Hz with active times of 60% and 50%, respectively. FIG. 2 presents the hydrogen permeation curves for the substrate steel, Pₛ, and for the pulsed-plasma ion-nitrided steel (Pₙₛ, Pₛₙ) for a frequency of 100 Hz and an active time equal to 60%. FIG. 3 presents the hydrogen permeation curves for the substrate steel, Pₛ, and for the pulsed-plasma ion-nitrided steel (Pₙₛ, Pₛₙ) for a frequency of 500 Hz and an active time equal to 50%.

Table 2 relates the hydrogen permeation parameters for the as-received substrate API X-65 steel and for this steel after pulsed-plasma ion-nitriding with frequencies of 100 Hz and 500 Hz with active times equal to 60% and 50%, respectively.

TABLE 2
Hydrogen Permeation Parameters for the as-received substrate and for the
pulsed-plasma ion-nitriding API X-65 steel using frequencies of 100 Hz and 500Hz.

| | | Active | | | Permeability |
|---|---|---|---|---|---|
| | | time | Difusivity | Solubility | P_{∞} |
| Material | Frequency | (%) | (m².s⁻¹) | (molH.m⁻³) | (molH.m⁻¹.s⁻¹) |
| Substrate | — | — | 2.47 × 10⁻¹⁰ | 0.81 | P_{∞s} = 2.10 × 10⁻¹⁰ |
| Steel | | | | | |
| Pulsed- | 100 Hz | 60 | 1.44 × 10⁻¹² | — | P_{∞ns} = 5.20 × 10⁻¹¹ |
| Plasma Ion- | | | | | P_{∞sn} = 1.17 × 10⁻¹² |
| Nitrided | 500 Hz | 50 | 2.16 × 10⁻¹² | | P_{∞ns} = 5.29 × 10⁻¹³ |
| Steel | | | | | P_{∞sn} = 1.75 × 10⁻¹² |

P_{∞}= the material's hydrogen permeability that is equal to the product of the hydrogen flux (higher plateau of the hydrogen permeation curve) by the sample thickness. It represents the maximum value the hydrogen permeation parameter may reach in each case.
P_{∞ns} = the hydrogen permeability in the material when hydrogen is generated on the nitrided layer and it is detected on the substrate during the electrochemical hydrogen permeation test.
P_{∞sn} = the hydrogen permeability in the material when hydrogen is generated on the substrate and it is detect on the nitrided layer during the electrochemical hydrogen permeation test.

Analysis of the hydrogen permeation curves and parameters for the substrate steel (Pₛ) and for the pulsed- plasma ion-nitrided steel (P₋ₙₛ and P₋ₙₛ) showed that the hydrogen permeability through the pulsed-plasma ion-nitrided steel is hundreds of times smaller than that verified through the substrate steel. Thus, the pulsed plasma ion nitriding consisted of an adequate method to create a diffusion barrier for hydrogen in steel. The decrease of the hydrogen permeation through the material is important to limit its hydrogen contamination and, as a result, the risk of hydrogen embrittlement. The on-service hydrogen contamination of the steel is facilitated because hydrogen is an element bearing the smallest atomic diameter, thus being very mobile through the material's structure by solid state diffusion. The deleterious effect of hydrogen modifies the contaminated material's mechanic-metallurgical properties, by reducing its ductility and fracture stress.

Such contamination may occur upon different situations involving reactions that liberate hydrogen on the metal's surface, as well as in hydrogen rich environments, such as those that are subject the mechanical components in petrochemical, chemical and nuclear industries or yet during fabrication and thermo-chemical processing, as well as upon the corrosion of steels.

1- Pulsed-plasma ion-nitriding process characterized by positioning the sample (1) that is the cathode itself, in the interior of a nitriding chamber (2), whose internal wall is the anode (3), wherein vacuum is made by means of a vacuum pump (4) until the pressure gauge (5) reads a pressure of, for example, equal to 30 mTorr (3.99×10⁻⁶ MPa), in which chamber a gas inlet (6) is used to introduce a nitrogen rich gaseous mixture with composition varying in the range N₂₊₀%-50% H₂, choosing a work pressure of, for example, about 4 Torr (5.33×10⁻⁴ MPa), and applying a difference of potential (7) that corresponds to a temperature of up to 400° C. measured by means of a thermocouple (8), such that the nitriding times are calculated from the sum of the periods of time that the plasma was active, so as to keep this total time a fixed value, and after finishing the nitriding treatment the samples are cooled within the nitriding chamber under a nitrogen atmosphere.

2- “Pulsed-Plasma Ion-Nitriding Process” in accordance with reinvindication 1, characterized to be a method to obtain a diffusion barrier for hydrogen in steel.

3- “Pulsed-Plasma Ion-Nitriding Process” in accordance with reinvindication 1, characterized to be performed in steel using an extended range of temperatures, from room temperature to 400° C., preferentially in temperatures between 300 and 400° C.

4- “Pulsed-Plasma Ion-Nitriding Process” in accordance with reinvindication 1, by making use of a gaseous mixture preferentially for the example disclosed in the range N₂+0%-20% H₂.

5- “Pulsed-Plasma Ion-Nitriding Process” in accordance with reinvindication 1, characterized by calculating the nitriding times from the summation of the times in which the plasma was active, in order to keep this total time at a fixed value.

6- “Pulsed-Plasma Ion-Nitriding Process” in accordance with reinvindication 1, characterized by measuring the hydrogen permeability in the pulsed-plasma ion-nitrided steel hundreds of times smaller than the hydrogen permeability in the substrate steel.
